(19) United States
(12) Patent Application Publication
(10) Pub. No.: US 2016/0308922 A1
(43) Pub. Date: Oct. 20, 2016

(54) SYSTEM AND METHOD FOR REAL-TIME REMOTE VIEWING OF REAL ESTATE

(71) Applicant: RTP Solutions Ltd., Langley (CA)

(72) Inventors: Anton Kristofer Venema, Surrey (CA); Jerod Andrius Venema, Apex, NC (US)

(21) Appl. No.: 15/098,924

(22) Filed: Apr. 14, 2016

Related U.S. Application Data
(60) Provisional application No. 62/147,549, filed on Apr. 14, 2015.

(51) Int. Cl. H04L 29/06; H04L 29/08

(52) U.S. Cl. CPC H04L 65/4069; H04L 67/104; G06Q 50/16

(57) ABSTRACT

A system for remote real estate viewing comprises a network; a local peer connected to the network, a remote peer connected to the network, and a recording peer connected to the network. Audio and video is streamed from the local peer to the remote peer to allow remote viewing of a property. Audio and video is also streamed from the local peer to the recording peer to record the remote viewing of the property.

### BACKGROUND OF THE INVENTION

1. Field of the Invention

The present invention relates to real-time remote viewing and, in particular, to a system and method for real-time remote real estate viewing using peer-to-peer connections.

2. Description of the Related Art

It is known to provide systems and methods for real-time remote real estate viewing.

United States Patent Application Publication No. 2006/005022 to Pratt discloses a system and method for real estate viewing using a camera to provide a real-time continuous audio feed between a local viewer and a remote viewer and a continuous video feed to the remote viewer. The camera is located on the property and moves in response to directions from the local viewer who is simultaneously communicating with the remote viewer.

United States Patent Application Publication No. 2009/0284578 to Carter discloses a system and method for real estate viewing using a two-way audio and video communication between a local viewer and a remote viewer using wireless handheld devices. Communication modules are located in each room on the property to allow the remote viewer to show the local viewer the property in real-time.

### SUMMARY OF THE INVENTION

There is accordingly provided system for remote viewing. The system comprises a network, a local peer connected to the network, a remote peer connected to the network, and a recording peer connected to the network. Audio and video is streamed from the local peer to the remote peer to allow remote viewing. Audio and video is also streamed from the local peer to the recording peer to record the remote viewing. The system may include an image recognition peer with a database having images and information related to the images. The information related to the images may be transmitted to and displayed on at least one of the local peer and the remote peer when an image is matched to video streamed from the local peer. The system may include a location analysis peer with a database of having a map. The map may be transmitted to and displayed on at least one of the local peer and the remote peer in response to movement of the local peer.

There is also provided system for remote real estate viewing. The system comprises a network, a local peer connected to the network, a remote peer connected to the network, and a recording peer connected to the network. Audio and video is streamed from the local peer to the remote peer to allow remote viewing of a property. Audio and video is also streamed from the local peer to the recording peer to record the remote viewing of the property. The system may include an image recognition peer with a database having images of the property and information related to the images of the property. The information related to the images of the property may be transmitted to and displayed on at least one of the local peer and the remote peer when an image is matched to video streamed from the local peer. The system may include a location analysis peer with a database of having a three dimensional spatial plan of the property. An overlay of the three dimensional spatial plan of the property may be transmitted to and displayed on at least one of the local peer and the remote peer in response to movement of the local peer about the property.

There is further provided a method for remote real estate viewing. The method comprises connecting a local peer to a network, connecting a remote peer to the network, and connecting a recording peer connected to the network. Audio and video is streamed from the local peer to the remote peer to allow remote viewing of a property. Audio and video is also streamed from the local peer to the recording peer to record the remote viewing of the property. The method may include connecting an image recognition peer with a database having images of the property and information related to the images of the property to the network. The information related to the images of the property may be transmitted to and displayed on at least one of the local peer and the remote peer when an image is matched to video streamed from the local peer. The method may include connecting a location analysis peer with a database of having a three dimensional spatial plan of the property to the network. An overlay of the three dimensional spatial plan of the property may be transmitted to and displayed on at least one of the local peer and the remote peer in response to movement of the local peer about the property.

### BRIEF DESCRIPTIONS OF DRAWINGS

The invention will be more readily understood from the following description of the embodiments thereof given, by way of example only, with reference to the accompanying drawings, in which:

FIG. 1 is a schematic of a distributed data processing system used to remotely show real estate property using peer-to-peer connections;

FIG. 2 is a schematic of the distributed data processing system used to remotely show other property using peer-to-peer connections; and

FIG. 3 is a flowchart showing communication between peers in the distributed data processing system.

### DESCRIPTIONS OF THE PREFERRED EMBODIMENTS

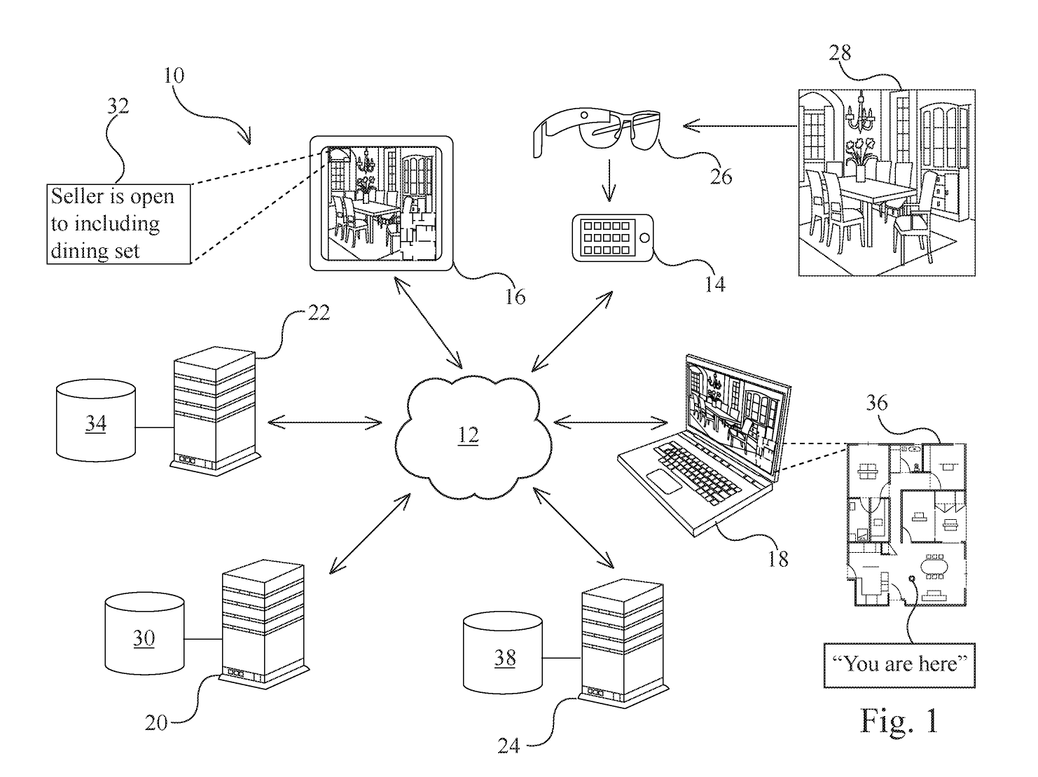

A distributed data processing system 10 that may be used to remotely show real estate property is shown in FIG. 1. The distributed data processing system 10 comprises a network 12 which, in this example, is the Internet but in other examples may be an intranet such as a wide area network (WAN) or a local area network (LAN). The distributed data processing system 10 also comprises a plurality of processors including a local peer 14, a first remote peer 16, a second remote peer 18, an image recognition peer 20, a location analysis peer 22, and a recording peer 24 which can communicate with one another over the network 12. It will be understood by a person skilled in the art that the distributed data processing system 10 may further comprise additional networks and processors that have not been shown. The peer-to-peer connections may be established via the IceLink™ software development kit available from Frozen Mountain Software Ltd. of 250-17667 65A Avenue, Surrey, British Columbia V3S 1Z8, Canada. The IceLink™ software development kit streams audio/visual information by links between peers using the WebRTC standard which in turn uses the Internet UDP protocol.

In this example, the local peer 14 is a smartphone which is in communication via Bluetooth™ wireless technology with an audio/video recording device 26 in the form of a Google Glass™. However, in other examples, the local peer may have integrated audio/video recording capabilities. The audio/video recording device 26 records audio and video as a local viewer tours a property. The local viewer may be a prospective buyer, a seller, a real estate agent or any other person. The recorded audio and video information including, for example, image 28 are streamed by the local peer 14 to other peers in the distributed data processing system 10.

The first remote peer 16 is a tablet and the second remote peer 18 is a laptop in this example. The first remote peer 16 and the second remote peer 18 each receive the recorded audio and video from the local peer 14 and display the audio and video information for respective remote viewers. The first remote peer 16 and the second remote peer 18 may also stream audio and video back to the local peer 14 and to one another. This allows for real-time communication between the local viewer and the remote viewers. Multiple prospective buyers are accordingly able to view a property from different locations in parallel. The prospective buyers are also able to communicate with one another via audio and video to allow the prospective buyers to jointly decide what to view next and discuss what is being viewed.

The image recognition peer 20 is a computer with a database 30 of images of a property and information related to the image. The image recognition peer 20 receives a continuous stream of at least video from the local peer 14. The video is analyzed by the image recognition peer in real-time to determine if the video contains an image of the property in the database 30. When a match is found to an image, for example, image 28 then the image recognition peer 20 retrieves information 32 related to the image 28 and transmits the information 32 to the other peers for display as shown for the first remote peer 16. The information 32 related to the image 28 may be provided by a seller or a real estate agent or any other person.

The location analysis peer 22 is a computer with a database 34 of three dimensional spatial plans each corresponding to a respective property. The location analysis peer 22 receives a continuous stream of at least video and movement information (left, right, up, down) from the local peer 14. The movement information, similar to the video, is captured on the Google Glass™ in this example and is transmitted by the local peer 14 to the location analysis peer 22. The video information and the movement information are analyzed by the location analysis peer 22 to create an overlay on a floor plan of the property, for example overlay 36, which is transmitted to the other peers for display as shown for the second remote peer 18. The overlay shows the location of the local viewer on the floor plan.

The recording peer 24 is a computer which receives a continuous stream of audio and video and other information from the local peer 14, the first remote peer 16, the second remote peer 18, the image recognition peer 20, and the location analysis peer 22. The audio and video received from the local peer 14, the first remote peer 16, and the second remote peer 18 is combined into a single audio/video stream and saved into a database 38 for future viewing. During a future viewing of the audio/video stream there may be the option of obtaining additional information for either the image recognition peer 20 or location analysis peer 22 including, but not limited to, a street map of the property area, a topographical map of the property area, a 360° street level view of the property, and a map showing schools and businesses in the area. The saved, single audio/video stream may be accessible via the Internet using any processor with audio/visual capabilities.

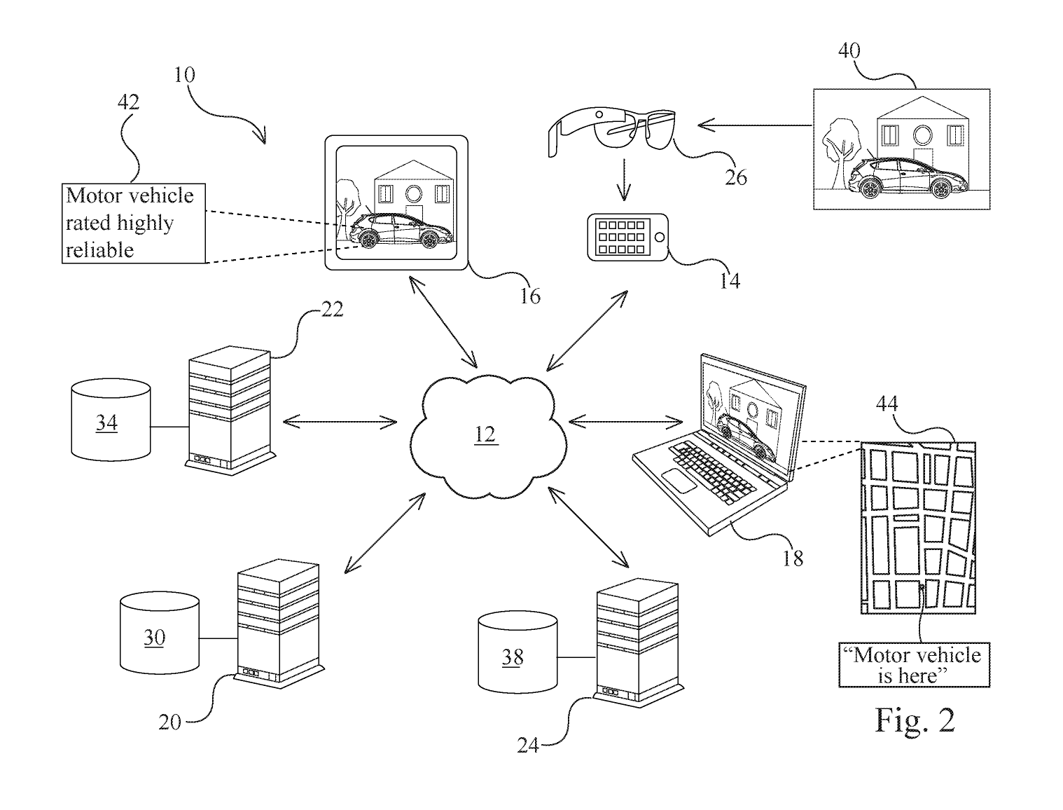

The distributed data processing system 10 is being used to remotely show real estate is shown in FIG. 1. However, the distributed data processing system 10 may also be used to remotely show other property, as shown in FIG. 2, in which a motor vehicle 40 being offered for sale is being shown. The image recognition peer 20 retrieves information 42 related to the motor vehicle 40 and may transmit the information 42 about the motor vehicle 40 to other peers for display, as shown for the first remote peer 16. The information 42 about the motor vehicle may be provided by a seller or any other person. Likewise, the location analysis peer 22 may provide a map 44 showing a location of the motor vehicle 40 based on a location of the local peer 14. It will accordingly be understood that the system and method disclosed herein may be used for any remote viewing purpose including non-commercial purposes.

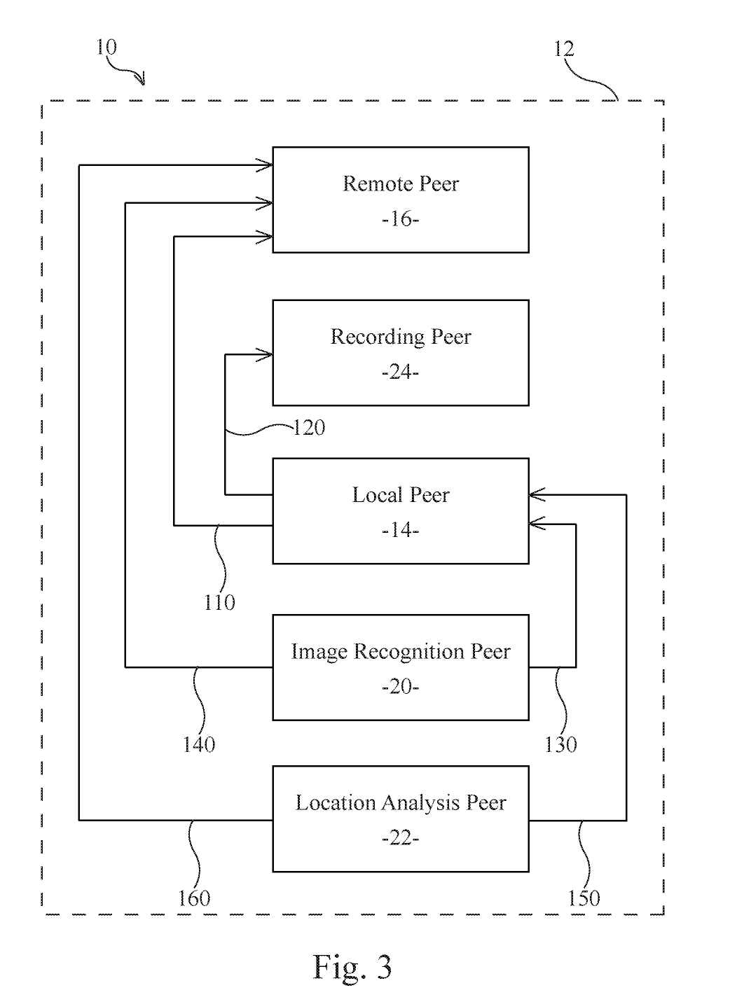

FIG. 3 is shows the communication between peers in the distributed data processing system 10. Audio and video is streamed from the local peer 14 to the remote peer 16, as indicated by arrow 110, to allow remote viewing. Audio and video is streamed from the local peer 14 to the recording peer 24, as indicated by arrow 120, to record the remote viewing. Information related to the images is transmitted by the image recognition peer 20 and displayed on at least one of the local peer 14 and the remote peer 16, as indicated by arrows 130 and 140, when an image is matched to video streamed from the local peer 14. Information is transmitted from the location analysis peer 22 and displayed on at least one of the local peer 14 and the remote peer 16, as indicated by arrows 150 and 160, in response to movement of the local peer.

In operation, the local viewer logs into the distributed data processing system 10 using the local peer 14 and an authorized viewing identification. The remote viewers also log into the distributed data processing system 10 using respective ones of the first remote peer 16 and the second remote peer 18 and a corresponding authorized viewing identification. Communication between the local viewer and the remote viewers is accomplished via WebSync™ available from Frozen Mountain Software Ltd. of 250-17667 65A Avenue, Surrey, British Columbia V3 S 1Z8, Canada. WebSync™ is a highly scalable HTTP streaming (comet) server which makes use of standard Internet communications using HTTPS over TCP/IP to carry out a setup process that allows all the users to locate each other in a secure manner.

It will be understood by a person skilled in the art that many of the details provided above are by way of example only, and are not intended to limit the scope of the invention which is to be determined with reference to the following claims.

What is claimed is:

1. A system for remote viewing, the system comprising:
a network;
a local peer connected to the network;
a remote peer connected to the network; and
a recording peer connected to the network;
wherein audio and video is streamed from the local peer to the remote peer to allow remote viewing, and audio and video is streamed from the local peer to the recording peer to record the remote viewing.

2. The system for remote viewing as claimed in claim 1 further including an image recognition peer with a database having images and information related to the images, wherein the information related to the images is transmitted to and displayed on at least one of the local peer and the remote peer when a said image is matched to video streamed from the local peer.

3. The system for remote viewing as claimed in claim 1 further including a location analysis peer with a database of having a map, wherein the map is transmitted to and displayed on at least one of the local peer and the remote peer in response to movement of the local peer.

4. A system for remote real estate viewing, the system comprising:
a network;
a local peer connected to the network;
a remote peer connected to the network; and
a recording peer connected to the network;
wherein audio and video is streamed from the local peer to the remote peer to allow remote viewing of a property, and audio and video is streamed from the local peer to the recording peer to record the remote viewing of the property.

5. The system for remote real estate viewing as claimed in claim 4 further including an image recognition peer with a database having images of the property and information related to the images of the property, wherein the information related to the images of the property is transmitted to and displayed on at least one of the local peer and the remote peer when a said image is matched to video streamed from the local peer.

6. The system for remote real estate viewing as claimed in claim 4 further including a location analysis peer with a database of having a three dimensional spatial plan of the property, wherein an overlay of the three dimensional spatial plan of the property is transmitted to and displayed on at least one of the local peer and the remote peer in response to movement of the local peer about the property.

7. A method for remote real estate viewing, the method comprising:
connecting a local peer connected to a network;
connecting a remote peer connected to the network;
connecting a recording peer connected to the network;
streaming audio and video is streamed from the local peer to the remote peer to allow remote viewing of a property; and
streaming audio and video is streamed from the local peer to the recording peer to record the remote viewing of the property.

8. The method for remote real estate viewing as claimed in claim 7 further including:
connecting an image recognition peer with a database having images of the property and information related to the images of the property to the network; and
transmitting and displaying the information related to the images of the property on at least one of the local peer and the remote peer when a said image is matched to video streamed from the local peer.

9. The method for remote real estate viewing as claimed in claim 7 further including:
connecting a location analysis peer with a database of having a three dimensional spatial plan of the property; and
transmitting and displaying an overlay of the three dimensional spatial plan of the property on at least one of the local peer and the remote peer in response to movement of the local peer about the property.
